(19) United States
(12) Patent Application Publication
(10) Pub. No.: US 2026/0366334 A1
(43) Pub. Date: Nov. 19, 2026

(54) DOOR LATCH ASSEMBLY CAPABLE OF AUTOMATIC UNLOCKING UPON POWER FAILURE AND HOUSEHOLD APPLIANCE HAVING THE SAME

(71) Applicant: ILLINOS TOOL WORKS INC., GLENVIEW, IL (US)

(72) Inventors: Xia WANG, Dongguan City (CN); Yang Wang, Dongguan City (CN)

(73) Assignee: ILLINOS TOOL WORKS INC., Glenview, IL (US)

(21) Appl. No.: 19/675,802

(22) Filed: May 13, 2026

(30) Foreign Application Priority Data
May 15, 2025 (CN) 202510629191.6

(51) Int. Cl. E05B 47/00

(52) U.S. Cl. CPC E05B 47/0004; E05B 2047/0076

(57) ABSTRACT

A door latch assembly having a first actuating mechanism and a door bolt movable between an unlocking and locking position. The first actuating mechanism moves the door bolt to the unlocking or locking position according to a control signal. The door latch assembly has a second actuating mechanism in a constantly energized state that exerts an elastic force on the door bolt along a locking movement direction. When the first actuating mechanism receives a control signal for locking, the first actuating mechanism allows the door bolt to move to the locking position under the elastic force of the second actuating mechanism. When the first actuating mechanism receives a control signal for unlocking, the first actuating mechanism overcomes the elastic force to move the door bolt to the unlocking position. When the door latch assembly loses power in the locking position, the second actuating mechanism automatically moves to the unlocking position.

### CROSS-REFERENCE TO RELATED APPLICATION

Chinese Patent Application No. CN 202510629191.6, filed on May 15, 2025, the priority document corresponding to this invention, to which a foreign priority benefit is claimed to under Title 35, United States Code, Section 119, and their entire teachings are incorporated, by reference, into this specification.

### BACKGROUND OF THE INVENTION

### Field of the Invention

The present invention relates to a door latch assembly capable of automatic unlocking upon power failure and household appliance having the same.

### Discussion of Related Art

In a household appliance, such as a washing machine, dryer and the like, an electrically controlled door latch assembly is usually used to automatically lock the door of the appliance after the appliance starts operating. For example, upon detection that a washing cycle of a washing machine or a drying cycle of a dryer has started, the controller sends a control signal to the electrically controlled door latch assembly to move the door bolt and lock the door of the appliance. After the washing cycle or drying cycle is completed, the controller again sends a control signal to the door latch assembly to move the door bolt and unlock the door of the appliance. In addition, the controller may also send a control signal to the door latch assembly according to the user's operation of the button or knob of the appliance. The control of the electrically controlled door latch assembly by the controller or the user is performed while the appliance is powered on normally.

In practice, there are cases where a sudden power outage in the environment of the appliance causes the appliance in operation to lose power. In such cases, the door of the appliance remains locked. Since the appliance is powered off at this time, the user or the controller can no longer unlock the door of the appliance through the electrically controlled door latch assembly. To address this, the electrically controlled door latch assembly is usually equipped with a manual mechanical unlocking apparatus. By means of this mechanical unlocking apparatus, the user can successfully unlock the door latch and open the door of the appliance in the event of a sudden power failure during operation of the appliance.

However, the mechanical unlocking apparatus occupies a large structural space within the door latch assembly and requires manual operation by the user. Therefore, a door latch assembly capable of automatically unlocking the door of the appliance upon power failure of the appliance is desired.

### SUMMARY OF THE INVENTION

To solve the technical problem described above, the present invention proposes a door latch assembly capable of automatic unlocking when the appliance loses power, requiring no manual operation by the user.

The basic inventive concept of the present invention is to provide an electrically controlled door latch assembly with two sets of actuating mechanisms, wherein a first actuating mechanism is used to perform locking and unlocking of the door of the appliance during normal operation of the appliance, the first actuating mechanism being energized according to a control signal, e.g., a pulse signal, to perform an action to change the position of a door bolt; and a second actuating mechanism is used to automatically unlock the door of the appliance when the appliance loses power, the second actuating mechanism being constantly energized during normal operation of the appliance. When the appliance suddenly loses power during operation, the second actuating mechanism is also de-energized, and automatically performs an action to change the position of the door bolt, thereby unlocking the door of the appliance.

The first actuating mechanism and the second actuating mechanism act on the same door bolt. The second actuating mechanism cannot affect the operation of the first actuating mechanism when the appliance is powered on normally, and the first actuating mechanism cannot affect the action performed by the second actuating mechanism when the appliance suddenly loses power during operation. To this end, when the appliance is powered on normally, the second actuating mechanism exerts an elastic force on the door bolt, and the first actuating mechanism is capable of overcoming the elastic force of the second actuating mechanism to control the movement of the door bolt. In the event of a sudden power failure during operation of the appliance, the first operating mechanism does not hinder the second operating mechanism from moving the door bolt. This depends on the manner in which the first actuating mechanism and the second actuating mechanism are connected with the door bolt. The connection manners of the door bolt will be described below in detail.

The present invention proposes a door latch assembly, having a first actuating mechanism and a door bolt, wherein the door bolt is movable between an unlocking position and a locking position, wherein the first actuating mechanism is capable of moving the door bolt to the unlocking position or the locking position according to a received control signal, wherein the door latch assembly has a second actuating mechanism, wherein the second actuating mechanism is constantly in an energized state during normal operation of the door latch assembly and exerts a predetermined elastic force on the door bolt along a locking movement direction of the door bolt; when the first actuating mechanism receives a control signal for locking, the first actuating mechanism allows the door bolt to move to the locking position under the elastic force of the second actuating mechanism; when the first actuating mechanism receives a control signal for unlocking, the first actuating mechanism is capable of overcoming the elastic force to move the door bolt to the unlocking position; and wherein, when the door latch assembly loses power and the door bolt is still in the locking position, the second actuating mechanism is capable of automatically moving the door bolt from the locking position to the unlocking position through its elastic restoring force.

In another aspect, the present invention proposes that the door bolt has a first engagement portion and a second engagement portion; and the door bolt engages with a first mating portion of the first actuating mechanism via the first engagement portion, and engages with a second mating portion of the second actuating mechanism via the second engagement portion.

In another aspect, the present invention proposes that the first engagement portion of the door bolt is configured as a columnar pin protruding from a door bolt base body, and the first mating portion of the first actuating mechanism is configured as a guide track, the columnar pin being slidable on the guide track.

In another aspect, the present invention proposes that the guide track is configured with a first sliding position at one end and a second sliding position at the other end; when the columnar pin slides into the first sliding position, the door bolt is moved to the unlocking position; and when the columnar pin slides into the second sliding position, the door bolt is moved to the locking position.

In another aspect, the present invention proposes that the first actuating mechanism is configured as an electromagnetic actuating mechanism, which has an electromagnetic actuator and a telescopic mechanism. The electromagnetic actuator has an electromagnetic coil and an iron core. The iron core extends into a central space of the electromagnetic coil. The electromagnetic coil is capable of causing the iron core to move along its axial direction, thereby actuating the telescopic mechanism to change state.

In another aspect, the present invention proposes that the telescopic mechanism has a slider, a swing arm, and a coil spring; the guide track is configured on a side surface of the slider facing the door bolt; the coil spring is sleeved on the outside of the iron core; the coil spring is supported on the electromagnetic coil on one end, and on the slider on the other end, and pushes them away from each other; and the iron core is fixedly connected to the slider.

In another aspect, the present invention proposes that a sliding slot is configured in the slider; one end of the swing arm is pivotable about a fixed axis, and the other end is slidable in the sliding slot; the sliding slot has a first detent and a second detent. When the swing arm swings into the first detent, the columnar pin of the door bolt slides into the first sliding position of the guide track, thereby moving the door bolt to the unlocking position; and when the swing arm swings into the second detent, the columnar pin slides into the second sliding position of the guide track, thereby moving the door bolt to the locking position.

In another aspect, the present invention proposes that the second engagement portion of the door bolt is configured with a first support region and a second support region. The second mating portion of the second actuating mechanism is configured as an elastic movable arm. An edge of the elastic movable arm can extend into a gap between the first support region and the second support region. The elastic movable arm is capable of exerting a predetermined elastic force on the first support region or the second support region of the door bolt.

In another aspect, the present invention proposes that the first support region and the second support region are configured as a recess in the door bolt base body, or the first support region and the second support region protrude from the door bolt base body.

In another aspect, the present invention proposes that the second actuating mechanism is configured as a PTC actuating mechanism, which has a heating PTC, an elastic movable arm, and a thermal deformation part. When the second actuating mechanism is energized, the temperature of the heating PTC increases, thereby causing the thermal deformation part to deform. The deformation of the thermal deformation part causes the elastic movable arm to exert an elastic force in the locking movement direction on the second support region of the door bolt.

In another aspect, the present invention proposes that when the second actuating mechanism is de-energized, the heating PTC cools down, thereby causing the thermal deformation part to return to its original shape. The return of the thermal deformation part to its original shape causes the elastic movable arm to also return to its original shape and exert an elastic force in an unlocking movement direction on the first support region of the door bolt.

In another aspect, the present invention proposes that the elastic movable arm has a peripheral region and a central region, the peripheral region and the central region being connected by a U-shaped spring.

In another aspect, the present invention proposes that the thermal deformation part is configured as a bimetallic strip, which is in direct or indirect contact with the central region of the elastic movable arm.

In another aspect, the present invention proposes that a protective PTC is connected in series with the first actuating mechanism.

In another aspect, the present invention proposes that the first actuating mechanism and the second actuating mechanism are connected in parallel.

A second aspect of the invention relates to a household appliance provided with a door latch assembly in accordance with the first aspect of the invention. Features and advantages applicable to the door latch assembly of the first aspect also apply correspondingly to the household appliance of the second aspect.

Preferred embodiments of the present invention and their advantages will be described in detail below in conjunction with the accompanying drawings.

### BRIEF DESCRIPTION OF SEVERAL VIEWS OF THE DRAWINGS

FIG. 1 shows a perspective view of a preferred embodiment of a door latch assembly according to the present invention;

FIG. 2 shows a perspective view of a door bolt of the door latch assembly according to FIG. 1;

FIG. 3 shows an exploded view of a first actuating mechanism of the door latch assembly according to FIG. 1;

FIG. 4 shows a perspective view of a slider of the first actuating mechanism according to FIG. 3;

FIG. 5 shows an exploded view of a second actuating mechanism of the door latch assembly according to FIG. 1;

FIG. 6 shows a perspective view of an elastic movable arm of the second actuating mechanism according to FIG. 5; and

FIG. 7 shows a circuit diagram of the door latch assembly according to FIG. 1.

### DESCRIPTION OF PREFERRED EMBODIMENTS

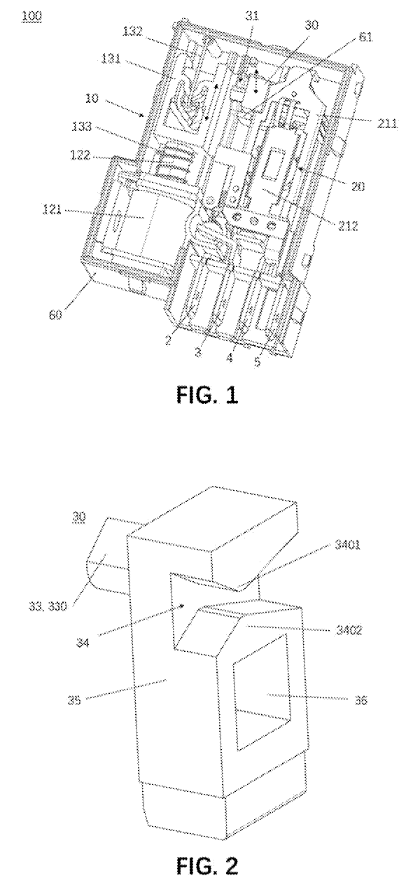

FIG. 1 shows a perspective view of a preferred embodiment of a door latch assembly 100 according to the present invention. The door latch assembly 100 can be installed in a household appliance, such as a washing machine or a dryer, for controlling locking and unlocking of the door of the appliance. In this preferred embodiment, the door latch assembly 100 has a door latch assembly housing 60 with a substantially square cross-section and a housing cover (not shown). A first actuating mechanism 10, a second actuating mechanism 20, and a door bolt 30 are installed in the door latch assembly housing 60. The first actuating mechanism 10 is configured as an electromagnetic actuating mechanism, and the second actuating mechanism 20 is configured as a PTC actuating mechanism. The first actuating mechanism 10 and the second actuating mechanism 20 each have a longitudinal extension direction. The longitudinal extension directions of the first actuating mechanism 10 and the second actuating mechanism 20 are substantially parallel, and the door bolt 30 is arranged between the first actuating mechanism 10 and the second actuating mechanism 20. This layout of the door latch assembly 100 achieves its compact structure.

The door bolt 30 is arranged in a door bolt accommodating portion 61 of the door latch assembly housing 60, and the bottom of the door bolt accommodating portion 61 has an opening (not shown in the figure). The door bolt 30 can move up and down in the door bolt accommodating portion 61 along the directions indicated by the double-headed arrow thereon. When the door bolt 30 moves upwards to a position in which its locking recess 36 retracts into the door latch assembly housing 60, the door bolt 30 is in an unlocking position 31. When the door bolt 30 moves downwards to a position in which its locking recess 36 extends out of the door latch assembly housing 60, the door bolt 30 is in a locking position 32. As shown in FIG. 1, the door bolt 30 is in the unlocking position 31 where its locking recess 36 is retracted into the door latch assembly housing 60.

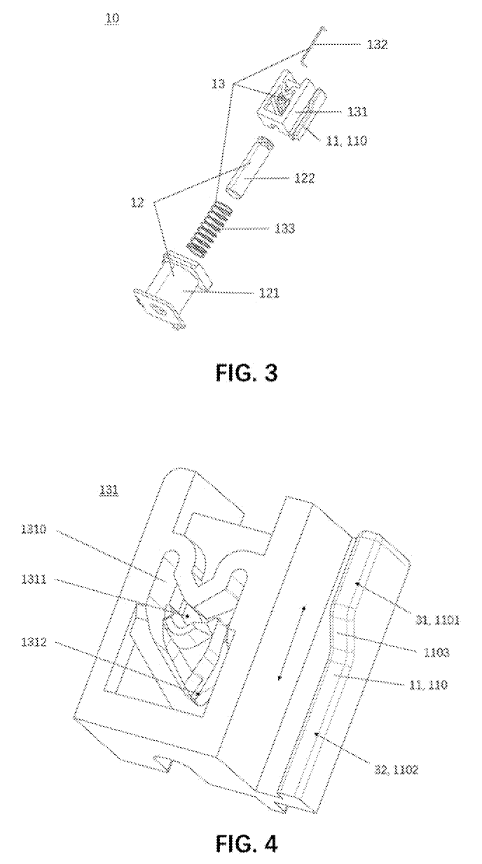

When the appliance is powered on normally, the first actuating mechanism 10 can control the door bolt 30 to move up and down in the door bolt accommodating portion 61 according to a control signal from a controller (not shown). To this end, the door bolt 30 has a first engagement portion 33, which can engage with a first mating portion 11 of the first actuating mechanism 10. As shown in FIG. 2, the first engagement portion 33 of the door bolt 30 is configured as a columnar pin 330 protruding from a door bolt base body 35. As shown in FIG. 3, the first mating portion 11 of the first actuating mechanism 10 is configured as a guide track 110, and the columnar pin 330 of the door bolt 30 can slide back and forth on the guide track 111.

As shown in FIG. 4, the guide track 110 is configured with a higher first sliding position 1101 at one end and a lower second sliding position 1102 at the other end, and a transition portion 1103 is configured between the first sliding position 1101 and the second sliding position 1102. In the preferred embodiment, the guide track 110 is configured in a polyline shape, and the first sliding position 1101 and the second sliding position 1102 form flat platforms. In a non-illustrated embodiment, it is also feasible for the guide track 110 to be configured in an arc shape, as long as the shape of the guide track 110 can ensure smooth movement of the door bolt 30 between the unlocking position 31 and the locking position 32. The guide track 110 is configured on the side surface of the slider 131 facing the door bolt 30.

When the columnar pin 330 slides into the higher first sliding position 1101, the door bolt 30 is moved upward to the unlocking position 31; when the columnar pin 330 slides into the second sliding position 1102, the door bolt 30 is moved downward to the locking position 32.

In the preferred embodiment, the door bolt 30 performs an up-and-down movement relative to the door latch assembly housing 60 along its height direction, while the slider 131 performs a forward-and-backward movement relative to the door latch assembly housing 60 along its longitudinal direction. The forward-and-backward movement of the slider 131 causes the up-and-down movement of the door bolt 30.

Referring to FIG. 3, to realize the forward-and-backward movement of the slider 131, the first actuating mechanism 10 has an electromagnetic actuator 12 and a telescopic mechanism 13. The electromagnetic actuator 12 has an electromagnetic coil 121 and an iron core 122. The iron core 122 extends into a central space of the electromagnetic coil 121, and the electromagnetic coil 121 is capable of causing the iron core 122 to move along its axial direction, thereby actuating the telescopic mechanism 13 to change state. The telescopic mechanism 13 has a slider 131, a swing arm 132, and a coil spring 133. The swing arm 132 is configured as a pin, which has substantially 90° bent portions at both ends of its rod-shaped base body. Referring to FIG. 1, one of the bent portions is inserted into a corresponding mounting groove of the door latch assembly housing 60 and can swing in the groove. The other bent portion is inserted into a sliding slot 1310 of the slider 131 and can slide along the sliding slot 1310. The coil spring 133 is sleeved on the outside of the iron core 122. One end of the coil spring 133 is supported on the electromagnetic coil 121. The electromagnetic coil 121 has a boss for supporting the coil spring 133. The boss is arranged around an opening on the electromagnetic coil 121 for accommodating the iron core 122. The other end of the electromagnetic coil 121 is supported on the side surface of the slider 131 facing the electromagnetic coil 121. The coil spring 133 pushes the electromagnetic coil 121 and the slider 131 away from each other. The iron core 122 forms a form-fitting connection with a corresponding notch on the slider 131 via an annular groove at its end facing the slider 131, so that the iron core 122 and the slider 131 move together.

In the preferred embodiment, when the electromagnetic coil 121 is energized, the electromagnetic coil 121 generates a magnetic attractive force on the iron core 122. Under the action of the magnetic attractive force, the iron core 122 and the slider 131 overcome the elastic force of the coil spring and move towards the electromagnetic coil 121, and extend into a corresponding opening of the electromagnetic coil 121.

Referring to FIG. 4, a heart-shaped sliding slot 1310 is configured in the slider 131. The sliding slot 1310 has a first detent 1311 and a second detent 1312. The bent portion of the pin 132 can stay either in the first detent 1311 or the second detent 1312. A sliding guide portion is configured between the first detent 1311 and the second detent 1312. When the pin 132 swings into the first detent 1311, the columnar pin 330 of the door bolt 30 slides into the first sliding position 1101 of the guide track 110, thereby moving the door bolt 30 to the upper unlocking position 31; when the pin 132 swings into the second detent 1312, the columnar pin 330 slides into the second sliding position 1102 of the guide track 110, thereby moving the door bolt 30 to the lower locking position 32.

In one actuation of the first actuating mechanism 10, a controller (not shown) sends a pulse signal to the electromagnetic coil 121 via terminal 53. Under the action of the pulse signal, the electromagnetic coil 121 generates a brief magnetic attractive force on the iron core 122. The iron core 122 and the slider 131 move towards the electromagnetic coil 121 under the attractive force, overcoming the elastic force of the coil spring 133, whereby the bent portion of the pin 132 can move out of the first detent 1311 or the second detent 1312 of the sliding slot 1310 and slide along the sliding guide portion to the opposite second detent 1312 or first detent 1311. In this way, the first actuating mechanism 10 moves the slider 131 and changes the state of the door bolt 30 via the pulse signal.

Referring to FIG. 2, to control the movement of the door bolt 30 via the second actuating mechanism 20 to automatically unlock the door of the appliance in the event of a power failure, the second engagement portion 34 of the door bolt 30 is configured with an upper first support region 3401 and a lower second support region 3402. In the preferred embodiment, the first support region 3401 and the second support region 3402 are configured as inner surfaces of a recess in the door bolt base body 35. In a non-illustrated embodiment, the first support region 3401 and the second support region 3402 can also protrude from the door bolt base body 35. In the embodiment shown in FIG. 2, the first support region 3401 and the second support region 3402 have a substantially triangular shape in a longitudinal cross-section, and a slender contact surface is formed at the vertex of the triangle. The first support region 3401 and the second support region 3402 have a minimum spacing at the contact surface. This shape of the first support region 3401 and the second support region 3402 ensures that the movement of the door bolt 30 can be controlled sensitively by the deformation of the elastic movable arm 210 discussed below.

Referring to FIG. 6, the second mating portion 21 of the second actuating mechanism 20 is configured as an elastic movable arm 210. An edge of the elastic movable arm 210 can extend into a gap between the first support region 3401 and the second support region 3402. The elastic movable arm 210 is capable of exerting a predetermined elastic force on the first support region 3401 or the second support region 3402 of the door bolt 30.

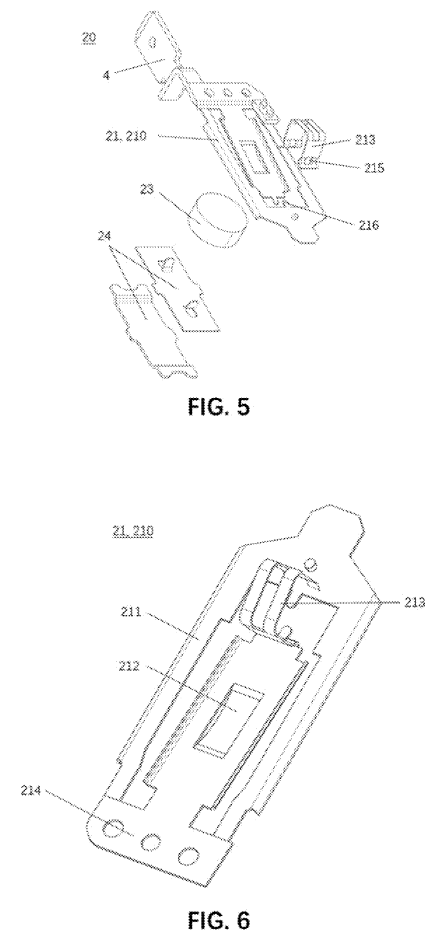

Referring to FIG. 5, the second actuating mechanism 20 is configured as a PTC actuating mechanism, which has a heating PTC 23, an elastic movable arm 210, and a thermal deformation part 24. When the second actuating mechanism 20 is energized, the heating PTC 23 is switched on and its temperature increases. The heating PTC 23 is in contact with the thermal deformation part 24 so that the thermal deformation part 24 is heated and deforms. The deformation of the thermal deformation part 24 causes the elastic movable arm 210 to exert an elastic force in the locking movement direction on the second support region 3402 of the door bolt 30.

When the second actuating mechanism 20 is de-energized, the heating PTC 23 cools down, thereby causing the thermal deformation part 24 to cool down and return to its original shape. The return of the thermal deformation part 24 to its original shape causes the elastic movable arm 210 to also return to its original shape and exert an elastic restoring force in the unlocking movement direction on the first support region 3401 of the door bolt 30. The door bolt 30 is thereby lifted from the guide track 110 of the first actuating mechanism 10 and moved into the unlocking position 31.

Referring to FIG. 6, the elastic movable arm 210 has a peripheral region 211, a central region 212, and a root portion 214. The peripheral region 211 and the central region 212 are fixed to the same root portion 214 and can elastically deflect relative to the root portion 214. The free ends of the peripheral region 211 and the central region 212 are connected by a U-shaped spring 213. The U-shaped spring 213 is snap-fitted to corresponding protrusions 216 on the peripheral region 211 and the central region 212 via notches 215 at its two ends. When the central region 212 of the elastic movable arm 210 springs upward, the U-shaped spring 213 can press the peripheral region 211 of the elastic movable arm 210 downward, thereby achieving downward springing of the peripheral region 211.

Referring to FIG. 5, in the preferred embodiment, the thermal deformation part 24 is configured as a bimetallic strip, which is in indirect contact with the central region 212 of the elastic movable arm 210. The heating PTC 23 is arranged between the bimetallic strip and the elastic movable arm 210 and is fixed in a form-fitting manner on the upper metal sheet of the bimetallic strip. When the heating PTC 23 is energized, its temperature increases, and the bimetallic strip in contact therewith is heated and deforms. The deformed bimetallic strip presses upward against the central region 212 of the elastic movable arm 210 via the heating PTC 23, causing it to spring upward. An adjusting screw (not shown) is provided below the bimetallic strip. By means of the adjusting screw, the spacing between the upper surface of the heating PTC 23 and the lower surface of the central region 212 can be adjusted. In a non-illustrated embodiment, the heating PTC 23 may also be arranged below the bimetallic strip, so that the bimetallic strip can be in direct contact with the central region 212 of the elastic movable arm 210.

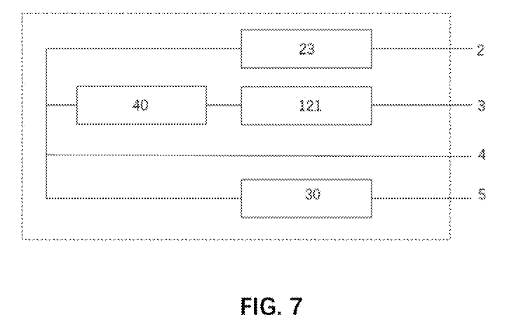

FIG. 7 shows a circuit diagram of the door latch assembly 100 according to FIG. 1. The door latch assembly 100 according to the present invention has terminals 2, 3, 4, and 5. The electromagnetic coil 121 of the first actuating mechanism 10 is energized via terminal 3. The heating PTC 23 of the second actuating mechanism 20 is energized via terminal 2. The first actuating mechanism 10 and the second actuating mechanism 20 are connected in parallel. The electromagnetic coil 121 of the first actuating mechanism 10 is connected in series with a protective PTC 40. The protective PTC 40 exhibits a low resistance during normal operation, allowing current to pass normally. When an overcurrent or abnormal temperature rise occurs in the circuit, its resistance value increases stepwise due to the temperature rise, thereby limiting the current. After the fault is cleared, the PTC can automatically return to its low-resistance state. A detection circuit is also provided in the door latch assembly 100. The detection circuit is connected to the door bolt 30 via port 5. When the door bolt 30 moves to the locking position 32, the detection circuit is, for example, switched on. When the door bolt 30 moves to the unlocking position 31, the detection circuit is, for example, switched off. The detection circuit can thus identify the position state of the door bolt 30.

An advantage of the present invention is that the door latch assembly 100 can automatically unlock the door of the appliance when the appliance loses power. This is achieved through the cooperation of the first actuating mechanism 10 and the second actuating mechanism 20. During normal operation of the appliance, the second actuating mechanism 20 cannot affect the normal actuation of the door bolt 30 movement by the first actuating mechanism 10. When the appliance loses power, the first actuating mechanism 10 cannot hinder the second actuating mechanism 20 from automatically moving the door bolt 30 to the unlocking position 31.

According to the present invention, the heating PTC 23 of the second actuating mechanism 20 is constantly energized during normal operation, and constantly exerts an elastic force in the locking movement direction on the second support region 3402 of the door bolt 30 via the downward springing of the peripheral region 211 of the elastic movable arm 210. When unlocking, the guide track 110 of the first actuating mechanism 10 can, through cooperation with the columnar pin 330, overcome the elastic force in the locking movement direction and forcibly move the door bolt 30 to the unlocking position 31. When locking, the guide track 110 of the first actuating mechanism 10, again through cooperation with the columnar pin 330, allows the door bolt 30 to move to the locking position 32 under the action of the elastic force in the locking movement direction. When the appliance suddenly loses power during operation, the door bolt 30 remains in the locking position. At this time, the columnar pin 330 of the door bolt 30 is in contact with the lower second sliding position 1102 of the guide track 110. As the appliance loses power, the heating PTC 23 in the second actuating mechanism 10 is also de-energized and gradually cools down. This causes the bimetallic strip and the elastic movable arm 210 to gradually return to their original shapes. During this process, the elastic movable arm 210 contacts the first support region 3401 of the door bolt 30 and exerts an elastic restoring force in the unlocking movement direction on the door bolt 30. The door bolt 30 is thereby lifted from the second sliding position 1102 of the guide track 110 and moved to the unlocking position. In this case, although the first actuating mechanism 10 remains in the locking state, the second actuating mechanism 20 still successfully moves the door bolt 30 to the unlocking position.

1. A door latch assembly (100) comprising:
a first actuating mechanism (10) and a door bolt (30), wherein the door bolt (30) is movable between an unlocking position (31) and a locking position (32), wherein the first actuating mechanism (10) is capable of moving the door bolt (30) to the unlocking position (31) or the locking position (32) according to a received control signal;
a second actuating mechanism (20), wherein the second actuating mechanism (20) is constantly in an energized state during normal operation of the door latch assembly (100) and exerts a predetermined elastic force on the door bolt (30) along a locking movement direction of the door bolt (30);
wherein when the first actuating mechanism (10) receives a control signal for locking, the first actuating mechanism (10) allows the door bolt (30) to move to the locking position (32) under the elastic force of the second actuating mechanism (20);
wherein when the first actuating mechanism (10) receives a control signal for unlocking, the first actuating mechanism (10) is configured to overcome the elastic force to move the door bolt (30) to the unlocking position (31); and
wherein when the door latch assembly (100) loses power and the door bolt (30) is in the locking position (32), the second actuating mechanism (20) is configured to automatically move the door bolt (30) from the locking position (32) to the unlocking position (31).

2. The door latch assembly (100) according to claim 1, wherein the door bolt (30) has a first engagement portion (33) and a second engagement portion (34) and the door bolt (30) engages with a first mating portion (11) of the first actuating mechanism (10) via the first engagement portion (33), and engages with a second mating portion (21) of the second actuating mechanism (20) via the second engagement portion (34).

3. The door latch assembly (100) according to claim 2, wherein the first engagement portion (33) of the door bolt (30) is configured as a columnar pin (330) protruding from a door bolt base body (35), and the first mating portion (11) of the first actuating mechanism (10) is configured as a guide track (110), the columnar pin (330) being slidable on the guide track (111).

4. The door latch assembly (100) according to claim 3, wherein a first sliding position (1101) and a second sliding position (1102) are configured on the guide track (110), and when the columnar pin (330) slides into the first sliding position (1101), the door bolt (30) is moved to the unlocking position (31), and when the columnar pin (330) slides into the second sliding position (1102), the door bolt (30) is moved to the locking position (32).

5. The door latch assembly (100) according to claim 4, wherein the first actuating mechanism (10) is configured as an electromagnetic actuating mechanism, which has an electromagnetic actuator (12) and a telescopic mechanism (13).

6. The door latch assembly (100) according to claim 5, wherein the electromagnetic actuator (12) has an electromagnetic coil (121) and an iron core (122), the iron core (122) extends into a central space of the electromagnetic coil (121), and the electromagnetic coil (121) is capable of causing the iron core (122) to move along its axial direction, thereby actuating the telescopic mechanism to change state.

7. The door latch assembly (100) according to claim 6, wherein the telescopic mechanism (13) has a slider (131), a swing arm (132) and a coil spring (133), wherein the guide track (110) is configured on the slider (131) and the coil spring (133) is sleeved on the outside of the iron core (122), further wherein the coil spring (133) is supported on the electromagnetic coil (121) on one end, and on the slider (131) on the other end, and pushes them away from each other, and the iron core (122) is fixedly connected to the slider (131).

8. The door latch assembly (100) according to claim 7, wherein a sliding slot (1310) is configured in the slider (131), one end of the swing arm (132) is pivotable about a fixed axis, and the other end is slidable in the sliding slot (1310), and the sliding slot (1310) has a first detent (1311) and a second detent (1312).

9. The door latch assembly (100) according to claim 8, wherein when the swing arm (132) swings into the first detent (1311), the columnar pin (330) of the door bolt (30) slides into the first sliding position (1101) of the guide track (110), thereby moving the door bolt (30) to the unlocking position (31), and when the swing arm (132) swings into the second detent (1312), the columnar pin (330) slides into the second sliding position (1102) of the guide track (110), thereby moving the door bolt (30) to the locking position (32).

10. The door latch assembly (100) according to claim 2, wherein the second engagement portion (34) of the door bolt (30) is configured with a first support region (3401) and a second support region (3402).

11. The door latch assembly (100) according to claim 10, wherein the second mating portion (21) of the second actuating mechanism (20) is configured as an elastic movable arm (210), wherein an edge of the elastic movable arm (210) can extend into an gap between the first support region (3401) and the second support region (3402), and the elastic movable arm (210) is capable of exerting a predetermined elastic force on the first support region (3401) or the second support region (3402) of the door bolt (30).

12. The door latch assembly (100) according to claim 11, wherein the first support region (3401) and the second support region (3402) are configured as a recess in the door bolt base body (35), or the first support region (3401) and the second support region (3402) protrude from the door bolt base body (35).

13. The door latch assembly (100) according to claim 12, wherein the second actuating mechanism (20) is configured as a PTC actuating mechanism, which has a heating PTC (23), an elastic movable arm (210), and a thermal deformation part (24).

14. The door latch assembly (100) according to claim 13, wherein when the second actuating mechanism (20) is energized, the temperature of the heating PTC (23) increases, thereby causing the thermal deformation part (24) to deform, and the deformation of the thermal deformation part (24) causes the elastic movable arm (210) to exert an elastic force in the locking movement direction on the second support region (3402) of the door bolt (30).

15. The door latch assembly (100) according to claim 14, wherein when the second actuating mechanism (20) is de-energized, the heating PTC (23) cools down, thereby causing the thermal deformation part (24) to return to its original shape, and the return of the thermal deformation part (24) to its original shape causes the elastic movable arm (210) to exert an elastic restoring force in an unlocking movement direction on the first support region (3401) of the door bolt (30).

16. The door latch assembly (100) according to claim 15, wherein the elastic movable arm (210) has a peripheral region (211) and a central region (212), the peripheral region (211) and the central region (212) being connected by a U-shaped spring (213).

17. The door latch assembly (100) according to claim 16, wherein the thermal deformation part (24) is configured as a bimetallic strip, which is in direct or indirect contact with the central region (212) of the elastic movable arm (210).

18. The door latch assembly (100) according to claim 17, wherein the heating PTC (23) is arranged between the bimetallic strip and the elastic movable arm (210).

19. The door latch assembly (100) according to claim 1, wherein a protective PTC (40) is connected in series with the first actuating mechanism (10).

20. The door latch assembly (100) according to claim 1, wherein the first actuating mechanism (10) and the second actuating mechanism (20) are connected in parallel.

21. A household appliance, comprising the door latch assembly (100) according to claim 1.
